(19) United States
(12) Patent Application Publication
(10) Pub. No.: US 2003/0065764 A1
(43) Pub. Date: Apr. 3, 2003

(54) Integrated diagnostic center

(76) Inventors: Karen Capers, Castle Rock, CO (US); Michael Brooking, Colorado Springs, CO (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/965,364

(22) Filed: Sep. 26, 2001

(51) Int. Cl. G06F 15/173; G09G 5/00

(52) U.S. Cl. 709/224; 345/736

(57) ABSTRACT

In a network, said network comprising multiple components coupled in a distributed manner wherein distributed programs execute across said multiple components and data associated with the execution of said distributed programs is generated by said multiple components; a novel method and system for logging distributed program trace data is disclosed, the method and system comprising steps and means for generating data associated with the execution of said distributed programs from each said multiple components; processing said data associated with the execution of said distributed programs from each said multiple components; and displaying said processed data to a user, said data associated with the execution of said distributed programs generated by said multiple components for a user of said network. Additionally, the system can dynamically adjust the level of diagnostic data available from a set of network elements according to user/operator specific commands.

### STATEMENT OF RELATED CASES

The following related cases are co-pending, co-owned patent applications—herein incorporated by reference—filed on even date as the present application:

Ser. No. ______ entitled “OBJECT COMMUNICATION SERVICES SOFTWARE DEVELOPMENT SYSTEM AND METHODS” to Karen Capers and Peter Alvin.

Ser. No. ______ entitled “PRESENTATION SERVICES SOFTWARE DEVELOPMENT SYSTEM AND METHODS” to Karen Capers and Laura Wiggett.

### BACKGROUND OF THE INVENTION

The convergence between legacy PBX, corporate IP Networks, on the one hand, and wireless communications, on the other, is continuing apace. Corporate GSM (or more generally, Office Land Mobile Network, or OLMN) systems that allow a subscribed user to roam onto a corporate wireless subsystem “campus” from the public land mobile network (PLMN) are known in the art.

With newer generations of such OLMNs rolling out, new services are being expected and demanded by the users of such systems. It is typically desirable to have such services—from new communications services to enhancing existing legacy services—seamlessly presented to the user (across the various platforms—PBX, network and wireless—within a given campus). Additionally, it is desirable to have these new services interoperating across various legacy PBX, networks and wireless subsystems—perhaps involving multiple manufacturers, protocols, operating systems and like.

It is additionally desirable to for these services to run robustly. Thus, messages can be delivered to end users even though there may be point failures in the OLMN. Additionally, it may be the case that, for communication systems developers, the location of the components that need to communicate on the network is not static, but changes often. Thus, it is desirable to have a development system that anticipates situations that require a wide variety of communication delivery modes and service. It is also desirable to have a development system that anticipates a wide variety of message formats that may differ in both their semantics and syntax.

Additionally, as these new services are being built and deployed across a disparate and distributed platform, there will be a need to debug the services and the programs that implement them. Thus, it is desirable to have the facility to trace program execution down to various levels into multiple components from a single user interface and also give an historical view of trace information in the form of a log. This is particular true for the fact that OLMN systems need to be debugged in their real-time operation mode. Thus, it is also desirable to view time sequenced trace information in real-time. It is also desirable to have more than one user (perhaps in different locations) view the same trace information simultaneously.

### SUMMARY OF THE INVENTION

The present invention discloses a novel system and method for logging distributed program trace data. In general, the present invention is deployed in a network comprising multiple components coupled in a distributed manner wherein distributed programs execute across said multiple components and data associated with the execution of said distributed programs is generated by said multiple components.

In general, a novel method and system for logging distributed program trace data is disclosed, the method and system comprising steps and means for generating data associated with the execution of said distributed programs from each said multiple components; processing said data associated with the execution of said distributed programs from each said multiple components; and displaying said processed data to a user, said data associated with the execution of said distributed programs generated by said multiple components for a user of said network.

### BRIEF DESCRIPTION OF THE DRAWINGS

FIG. 1 is a typical embodiment of an OLMN architecture.

FIGS. 2 and 3 depict the operational aspect of the present invention by way of Use-Case descriptions.

FIGS. 4-7 give a pictorial description of the logical architecture class diagrams of the current embodiment.

FIG. 8 is a view of a diagnostic center Use-Case Diagram.

### DETAILED DESCRIPTION OF THE INVENTION

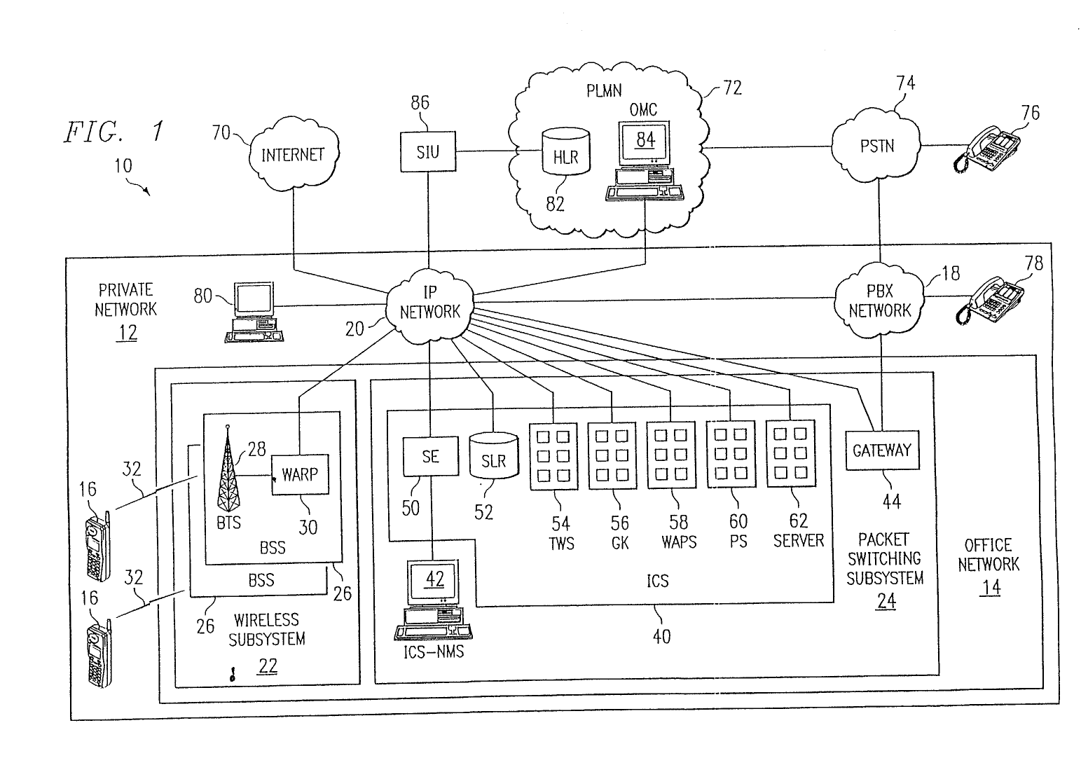

FIG. 1 depicts a typical architecture of an Office Land Mobile Network (e.g. Corporate GSM or “C-GSM”)—illustrating a communication system 10 in accordance with one embodiment of the present invention. The system 10 comprises a private network 12 for providing communication for a plurality of authorized subscribers. According to one embodiment, the private network 12 comprises a communication network for a particular business enterprise and the authorized subscribers comprise business personnel. The private network 12 comprises an office network 14 for providing communication between a plurality of mobile devices 16, a private branch exchange (PBX) network 18, and an Internet Protocol (IP) network 20.

The office network 14 comprises a wireless subsystem 22 for communicating with the mobile devices 16 and a packet switching subsystem 24 for providing operations, administration, maintenance and provisioning (OAMP) functionality for the private network 12. The wireless subsystem 22 comprises one or more base station subsystems (BSS) 26. Each base system subsystem 26 comprises one or more base transceiver stations (BTS), or base stations, 28 and a corresponding wireless adjunct Internet platform (WARP) (alternatively called “IWG”) 30. Each base station 28 is operable to provide communication between the corresponding WARP 30 and mobile devices 16 located in a specified geographical area.

Authorized mobile devices 16 are operable to provide wireless communication within the private network 12 for authorized subscribers. The mobile devices 16 may comprise cellular telephones or other suitable devices capable of providing wireless communication. According to one embodiment, the mobile devices 16 comprise Global System for Mobile communication (GSM) Phase 2 or higher mobile devices 16. Each mobile device 16 is operable to communicate with a base station 28 over a wireless interface 32. The wireless interface 32 may comprise any suitable wireless interface operable to transfer circuit-switched or packet-switched messages between a mobile device 16 and the base station 28. For example, the wireless interface 32 may comprise a GSM/GPRS (GSM/general packet radio service) interface, a GSM/EDGE (GSM/enhanced data rate for GSM evolution) interface, or other suitable interface.

The WARP 30 is operable to provide authorized mobile devices 16 with access to internal and/or external voice and/or data networks by providing voice and/or data messages received from the mobile devices 16 to the IP network 20 and messages received from the IP network 20 to the mobile devices 16. In accordance with one embodiment, the WARP 30 is operable to communicate with the mobile devices 16 through the base station 28 using a circuit-switched protocol and is operable to communicate with the IP network 20 using a packet-switched protocol. For this embodiment, the WARP 30 is operable to perform an interworking function to translate between the circuit-switched and packet-switched protocols. Thus, for example, the WARP 30 may packetize messages from the mobile devices 16 into data packets for transmission to the IP network 20 and may depacketize messages contained in data packets received from the IP network 20 for transmission to the mobile devices 16.

The packet switching subsystem 24 comprises an integrated communication server (ICS) 40, a network management station (NMS) 42, and a PBX gateway (GW) 44. The ICS 40 is operable to integrate a plurality of network elements such that an operator may perform OAMP functions for each of the network elements through the i15 ICS 40. Thus, for example, an operator may perform OAMP functions for the packet switching subsystem 24 through a single interface for the ICS 40 displayed at the NMS 42.

The ICS 40 comprises a plurality of network elements. These network elements may comprise a service engine 50 for providing data services to subscribers and for providing an integrated OAMP interface for an operator, a subscriber location register (SLR) 52 for providing subscriber management functions for the office network 14, a teleworking server (TWS) 54 for providing PBX features through Hicom Feature Access interfacing and functionality, a gatekeeper 56 for coordinating call control functionality, a wireless application protocol server (WAPS) 58 for receiving and transmitting data for WAP subscribers, a push server (PS) 60 for providing server-initiated, or push, transaction functionality for the mobile devices 16, and/or any other suitable server 62.

Each of the network elements 50, 52, 54, 56, 58, 60 and 62 may comprise logic encoded in media. The logic comprises functional instructions for carrying out program tasks. The media comprises computer disks or other computer-readable media, application-specific integrated circuits (ASICs), field-programmable gate arrays (FPGAs), digital signal processors (DSPs), other suitable specific or general purpose processors, transmission media or other suitable media in which logic may be encoded and utilized. As described in more detail below, the ICS 40 may comprise one or more of the servers 54, 58, 60 and 62 based on the types of services to be provided by the office network 14 to subscribers as selected by an operator through the NMS 42.

The gateway 44 is operable to transfer messages between the PBX network 18 and the IP network 20. According to one embodiment, the gateway 44 is operable to communicate with the PBX network 18 using a circuit-switched protocol and with the IP network 20 using a packet-switched protocol. For this embodiment, the gateway 44 is operable to perform an interworking function to translate between the circuit-switched and packet-switched protocols. Thus, for example, the gateway 44 may packetize messages into data packets for transmission to the IP network 20 and may depacketize messages contained in data packets received from the IP network 20.

The communication system 10 may also comprise the Internet 70, a public land mobile network (PLMN) 72, and a public switched telephone network (PSTN) 74. The PLMN 72 is operable to provide communication for mobile devices 16, and the PSTN 74 is operable to provide communication for telephony devices 76, such as standard telephones, clients and computers using modems or digital subscriber line connections. The IP network 20 may be coupled to the Internet 70 and to the PLMN 72 to provide communication between the private network 12 and both the Internet 70 and the PLMN 72. The PSTN 74 may be coupled to the PLMN 72 and to the PBX network 18. Thus, the private network 12 may communicate with the PSTN 74 through the PBX network 18 and/or through the IP network 20 via the PLMN 72.

The PBX network 18 is operable to process circuit-switched messages for the private network 12. The PBX network 18 is coupled to the IP network 20, the packet switching subsystem 24, the PSTN 74, and one or more PBX telephones 78. The PBX network 18 may comprise any suitable network operable to transmit and receive circuit-switched messages. In accordance with one embodiment, the gateway 44 and the gatekeeper 56 may perform the functions of a PBX network 18. For this embodiment, the private network 12 may not comprise a separate PBX network 18.

The IP network 20 is operable to transmit and receive data packets to and from network addresses in the IP network 20. The IP network 20 may comprise a local area network, a wide area network, or any other suitable packet-switched network. In addition to the PBX network 18, the Internet 70 and the PLMN 72, the IP network 20 is coupled to the wireless subsystem 22 and to the packet switching subsystem 24.

The IP network 20 may also be coupled to an external data source 80, either directly or through any other suitable network such as the Internet 70. The external data source 80 is operable to transmit and receive data to and from the IP network 20. The external data source 80 may comprise one or more workstations or other suitable devices that are operable to execute one or more external data applications, such as MICROSOFT EXCHANGE, LOTUS NOTES, or any other suitable external data application. The external data source 80 may also comprise one or more databases, such as a corporate database for the business enterprise, that are operable to store external data in any suitable format. The external data source 80 is external in that the data communicated between the IP network 20 and the external data source 80 is in a format other than an internal format that is processable by the ICS 40.

The PLMN 72 comprises a home location register (HLR) 82 and an operations and maintenance center (OMC) 84. The HLR 82 is operable to coordinate location management, authentication, service management, subscriber management, and any other suitable functions for the PLMN 72. The HLR 82 is also operable to coordinate location management for mobile devices 16 roaming between the private network 12 and the PLMN 72. The OMC 84 is operable to provide management functions for the WARPs 30. The HLR 82 may be coupled to the IP network 20 through an SS7-IP interworking unit (SIU) 86. The SIU 86 interfaces with the WARPs 30 through the IP network 20 and with the PLMN 72 via a mobility-signaling link.

Overview and Terminology

It is known that nearly every large application includes its own logging or tracing API. The present invention therefore is able to bootstrap using some well-known APIs, such as the Log4j APIs. The ICS Logging system provides precise context about the running of the ICS application. For ICS logging, output requires no human intervention and the output can be saved in a persistent medium to be studied at a later time.

One benefit of using log4j is that it is possible to enable logging at runtime without modifying the application binary. The log4j package is designed so that these statements can remain in shipped code without incurring a heavy performance cost. Logging behavior can be controlled by editing a configuration file, without touching the application binary. Configuration files can be property files or in XML format or some other suitable format.

The target of the log output can be a file, an OutputStream, a java.io.Writer, a remote log4j server, a remote Unix Syslog daemon or even an NT Event logger.

The presently claimed Logging Framework could be installed as a part of ICS. The ICS logging architecture includes loggers (categories), handlers (Appenders), filters, formatters and the main controller Diagnostic center, which controls the entire logging system by friendly graphical user interface. In this framework, there are 5 priority levels, namely DEBUG, INFO, WARN, ERROR and FATAL.

Appenders—Appenders process the event data generated by the categories. Appenders correspond to a physical device, such as a console, file or socket. They usually, but not always, format the data. At least one appender should be attached to a category or the event data might be lost.

Categories—Categories generate the data to be logged. They may be turned on and off individually. Message loggers provide information useful to end-users and administrators. Trace loggers provide debug information for program development and problem determination in the field.

Diagnostic Center—The Diagnostic center controls the entire logging system. This center provides the online logging and tracing of the individual frameworks of the ICS application. This system also provides various options of logging and tracing on individual frameworks. This center provides the facility for configuring the entire logging and tracing system.

The Diagnostic Center could be implemented as a GUI application that administers Logging Configurations and displays Log Messages. It administers two Logging Configurations: (1) Historical Logging Configuration and the (2) Diagnostic Center Instance Configuration. It has display two modes: Real-Time and Historical. Multiple instances of the Diagnostic Center can be run simultaneously, each of which has its own instance configuration. If no instances of the Diagnostic Center are running then only historical logging is being performed.

Diagnostic Center Instance Configuration—For a Diagnostic Center's Real-Time Mode, the settings of which Log Messages are sent only to this particular application instance.

Historical Logging Configuration—A system-wide setting of which Log Messages are to be persisted in the Logging Repository. Any instance of the Diagnostic Center can read or modify the Historical Logging Configuration.

Historical Log Message—Log Messages that are persisted in the Logging Repository whether or not any instances of a Diagnostic Center are running. The settings are dictated by the Historical Logging Configuration.

Historical Mode—A mode of a Diagnostic Center that queries the Logging Repository for a snapshot of historical Log Messages based on specific criteria.

Logging API—The application program interface (API) that a Logging Source uses to generate Log Messages. There are APIs for both Java and C++.

Logging Destination—There are two types of destinations: the single Logging Repository or an instance of a Diagnostic Center.

Logging Source—Java or C++ source code that generates Log Messages.

Logging Repository—A Logging Destination that persists Historical Log Messages in either a database or rolling file mechanism.

Log Level—An integer that specifies a level of logging. The effect is cumulative, i.e., each value includes itself and smaller values. E.g., TRACE3 cumulatively includes (ERROR, TRACE1, TRACE2, and TRACE3). The higher the value the greater the amount of trace should be logged.

| Value | Meaning | Description |
|---|---|---|
| 0 | OFF | Not logging anything. |
| 1 | ERROR | Programmatic errors like |
| | | assertion violations (logic errors) |
| | | and run-time exceptions caught in |
| | | try/catch constructions, etc. |
| 2 | TRACE1 | Significant/important “first look” |
| | | trace. |
| 3 | TRACE2 | TBD |
| 4 | TRACE3 | TBD |
| 5 | TRACE4 | TBD |
| 6 | TRACE5 | Esoteric trace that is turned on |
| | | infrequently. |

Log Message—An instance of a message generated by a Logging Source and sent to a Logging Destination.

Real-Time Mode—A mode of a Diagnostic Center where Log Messages are received directly from a Logging Source without being persisted in the Logging Repository.

Architecture

The system uses the following OCS point names:

| Point Name | Description |
|---|---|
| LogSource* | Each Logging Source will have an OCS point |
| | named “LogSourceX” where X is arbitrarily |
| | assigned by the OCS Server. This name is |
| | unimportant. |
| LoggingRepository | The central Logging Repository registers with this |
| | point name. |
| DiagnosticCenter* | Each Diagnostic Center instance will have an OCS |
| | point named “DiagnosticCenterX” where X is |
| | arbitrarily assigned by the OCS Server. This name |
| | is important. Logging Sources will send point-to- |
| | point messages to these point names. |

The system uses the following Pub/Sub Topic:

| Topic Name | Description |
|---|---|
| LogConfiguration | When a Diagnostic Center changes the Historical |
| | Logging Configuration or a Diagnostic Center |
| | Instance Configuration the configuration is |
| | published to this topic. The Logging Repository and |
| | each Logging Source must subscribe to this topic for |
| | updates. |

### Configuration Message Format

When a Diagnostic Center changes the Historical Logging Configuration or a Diagnostic Center Instance Configuration the configuration is published to the LogConfiguration topic.

These messages are only sent when the configuration changes. Therefore, Logging Sources must persist these configurations so that they will have the latest version of the configuration for each time they start.

The OCSMap format is as follows:

| OCSMap Name/ | | |
|---|---|---|
| Value Pair | OCS Datatype | Description |
| LogDestination | String | Contains exactly either |
| | | “LoggingRepository” or |
| | | “DiagnosticCenterX” |
| Configuration | String | Describes each class that has |
| | | logging enabled. Details below. |

The Configuration name/value pair is a multi-line string that has this syntax for easy parsing:

scope:class:level <CRLF>

scope:class:level <CRLF>

. . .

where each item is described thus:

| Item | Datatype | Description |
|---|---|---|
| Scope | String | The C++ name space of the Java |
| | | package. |
| Class | String | The name of the class. |
| Level | Integer | 1-6 depicting a logging level. |

Examples:

SLR:someClass:5

com.opuswave.ics.serviceEngine.core.threadpool:ThreadPool:1

Turning Off (Disabling) Levels of Trace

When a configuration message is received from a Logging Destination the Logging Source should over write the previous configuration for that destination.

It is often desirable to overwrite the previous configuration. For example, when Logging Destination TURNS OFF (level 0) messages for a particular class, the subsequent configuration will not contain an entry for the class that was turned off.

Instead, the previous entry will be OMITTED.

Example

Given the configuration above: If the SLR's class is disabled then the subsequent configuration will contain this:

com.opuswave.ics.serviceEngine.core.threadpool:ThreadPool:1

not this:

SLR:someClass:0 #NO!

com.opuswave.ics.serviceEngine.core.threadpool:ThreadPool:1

Log Message Format

The OCSMap format is as follows for messages that are logged:

| OCS Map Name/ | | |
|---|---|---|
| Value Pair | OCS Datatype | Description |
| Timestamp | String | Date and time in the following |
| | | format: DD/MM/YYYY |
| | | HH:MM:SS. |
| Level | Long | 1-6 depicting a logging level. |
| Scope | String | C++ name space or Java package. |
| Class | String | The name of the class. |
| Filename | String | The filename that contains the |
| | | class. |
| Method | String | The method that logs the |
| | | message. |
| Line | Long | The line number that logs the |
| | | message. |
| Message | String | The message. The message is |
| | | free-form arbitrary text. |

The Logging Source sends these OCSMap objects to the Logging Destinations. If the sendMap fails with a “unknown point” error when sending to a Diagnostic Center that it is assumed that the Diagnostic Center instance has exited and the Logging Source should remove the configuration for that destination.

System Use-Case Descriptions

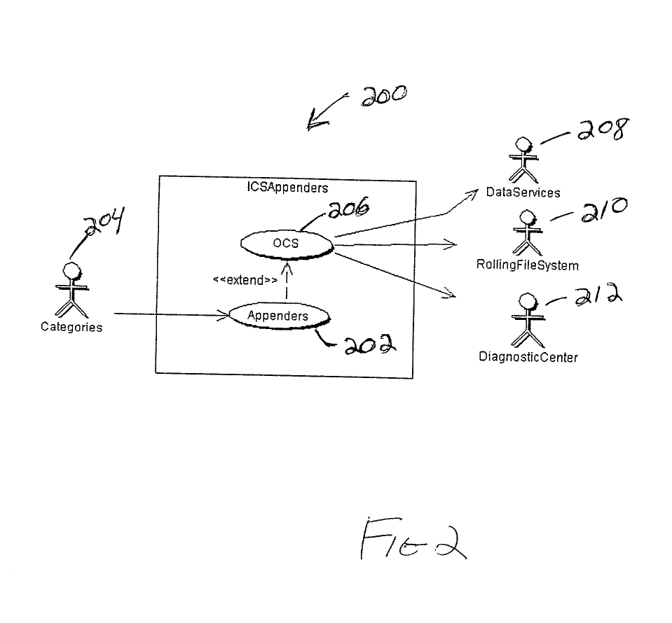

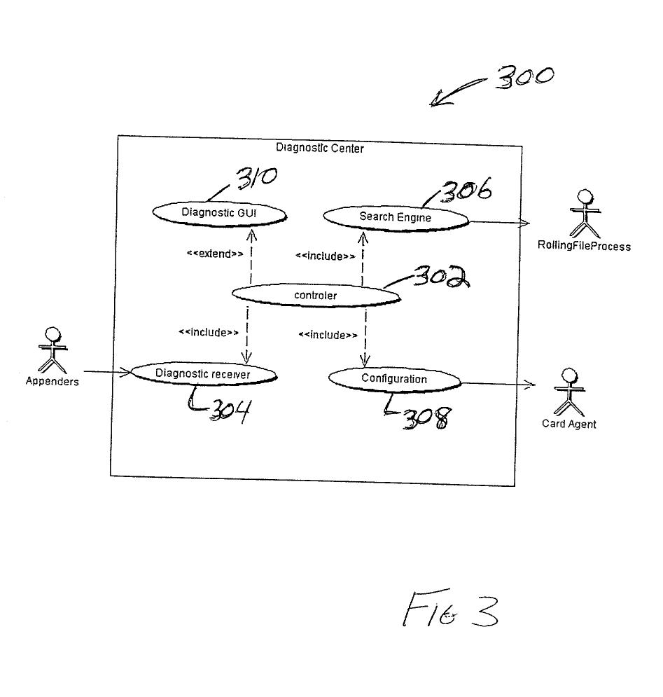

FIGS. 2 and 3 depict the operational aspect of the present invention by way of Use-Case descriptions. Use-Case descriptions are the well known way to express static and dynamic features of software in UML.

System: Logging and Tracing process

The ICS Logging system provides precise context about the running of the ICS application. According to the config file, the Categories log the messages by calling the call back methods of the Appenders which are configured for that category. These appenders use the Object Communications Service (OCS) for sending this messages to the different entities like Data Services, Rolling File System, and Diagnostic center. The OSC subsystem is described in greater detail in the co-pending patent application mentioned in the Statement of Related Cases and is herein incorporated by reference. It will be appreciated that other communication subsystem used to facilitate communications between the various multiple components of the network might also suffice for the purposes of the present invention.

System Use Case: Appenders

In FIG. 2, Appenders 202 process the event data generated by the categories 204. Appenders use the OCS 206 to communicate with Data Services 208, Rolling File System 210 and Diagnostic center 212. At least one appender should be attached to a category or the event data may become lost.

Flow of Events

Scenario: Basic Flow

1. Generate the data for logging.

2. Call the logging system according to the priority.

3. Callback methods of the attached Appenders are called.

Post-Conditions

The Appenders sends the event data to the Diagnostic center, Rolling File System and Data Services using the OCS.

Related Use Cases

Extends use cases:

OCS

System Use Case: OCS

The Appenders use the OCS for sending the messages to the Data Services, Rolling File System and Diagnostic center.

System Actors

Secondary: Diagnostic center. 212

Secondary: Rolling File System. 210

Secondary: Data Services. 208

Pre-Conditions

All the receivers should subscribe to OCS.

Flow of Events

Scenario: Basic Flow

1. Categories call the Callback methods of the attached Appenders.

2. Callback methods pass the logging event through the OCS.

Post-conditions

No acknowledgement need be returned.

Related Use Cases

Extended in use cases:

Appenders

System: Diagnostic Center

In FIG. 3, the Diagnostic center 300 controls the entire logging system. This center provides the online logging and tracing of the individual frameworks of the ICS application. This system also provides various options of logging and tracing on individual frameworks. This center provides the facility for configuring the entire logging and tracing system.

System Use Case: Controller

Controller 302 has the responsibility to control all the logging information according to the options provided. The configuration of the whole logging system is also controlled.

Pre-Conditions

Start the Diagnostic center.

Flow of Events

Scenario: Receiving the Logs

1. Diagnostic Receiver receives the logging event data.

2. The on-line Live table shows received logging event data.

Scenario: Dynamic Configuring the Logging System

1. Configure the logging system by GUI.

2. This configuration is updated in all cards.

Scenario: Querying the Rolling File System

1. Select the options for getting the persisted log data.

Post-conditions

Stop the Diagnostic center.

Related Use Cases

Includes use cases:

Diagnostic receiver. 304

Search Engine. 306

Configuration. 308

Extends use cases:

Diagnostic GUI. 310

System Use Case: Diagnostic Receiver

Diagnostic receiver 304 is the subscriber to Diagnostic Topic, which receives all the logging event objects from the appenders. The controller controls this diagnostic receiver.

System Actors

Primary: Appenders.

Pre-Conditions

Start Diagnostic center.

Flow of Events

Scenario: Basic Flow

1. Diagnostic Receiver receives the logging event data.

2. The on-line Live table shows received logging event data.

Related Use Cases

Included in use cases:

Controller.

System Use Case: Diagnostic GUI

Diagnostic GUI 310 is the friendly graphical user interface for viewing online logging and tracing of the individual frameworks of the ICS application with different options. It also provides for configuring the entire logging system dynamically.

Pre-Conditions

Start Diagnostic center.

Flow of Events

Scenario: Basic Flow

1. Diagnostic Receiver receives the logging event data.

2. The on-line Live table shows received logging event data.

3. Search Engine gives back result data, which is shown in off-line table.

4. GUI facilitates the dynamic configuration of logging system.

Related Use Cases

Extends use cases:

Controller.

System Use Case: Configuration

Configuration 308 provides to configure the entire logging system at runtime with different options.

Pre-Conditions

Start Diagnostic center.

Flow of Events

Scenario: Basic Flow

1. Provide different options for configuring by the diagnostic GUI.

Related Use Cases

Included in use cases:

Controller

System Use Case: Search Engine

Search Engine 306 is used to query the Rolling File System for the logs. It provides options for the user for querying.

The controller controls this search engine.

System Actors

Secondary: Rolling File Process.

System Objects

Pre-Conditions

Start Diagnostic center.

Flow of Events

Scenario: Basic Flow

1. Search Engine queries the Rolling File Process.

2. The result data is shown in off-line table.

Related Use Cases

Included in use cases:

Controller.

Logical Architecture Class Diagrams

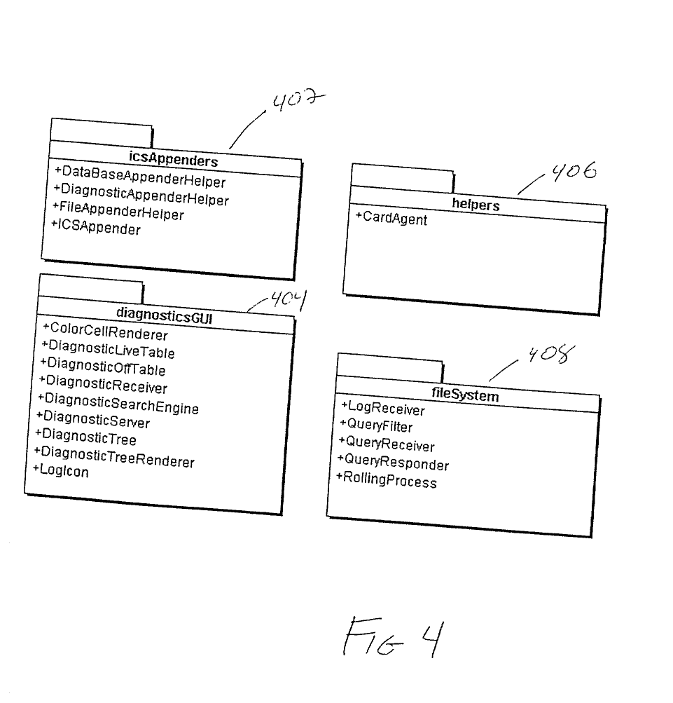

Having given a description of a current embodiment in Use-Case diagrams, the logical architecture class diagrams of the current embodiment will now be given. The following written description should be read in conjunction with FIGS. 4-7 for a pictorial description of the classes.

Package Nodes Details (FIG. 4)

Package com.opuswave.ics.serviceEngine.icsLog. icsAppenders 402

Package com.opuswave.ics.serviceEngine.icsLog. diagnosticsGUI 404

Package com.opuswave.ics.serviceEngine.icsLog. helpers 406

Package com.opuswave.ics.serviceEngine.icsLog. fileSystem 408

Package com.opuswave.ics.serviceEngine.icsLog. icsAppenders

Class com.opuswave.ics.serviceEngine.icsLog.

icsAppenders.DataBaseAppender

Class com.opuswave.ics.serviceEngine.icsLog.

icsAppenders.DiagnosticAppender

Class com.opuswave.ics.serviceEngine.icsLog. icsAppenders.FileAppender

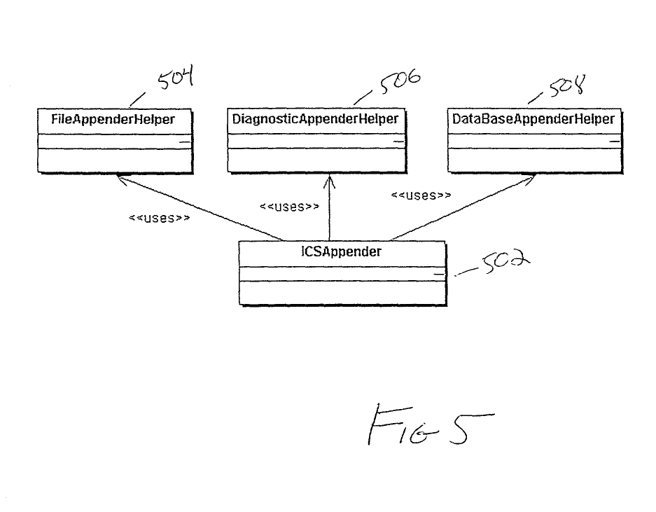

ICSAppender (FIG. 5)

ICSAppender 502 is a class, which uses FileAppenderHelper, DiagnosticAppenderHelper and DataBaseAppenderHelper for sending the logs to Rolling File Process, Diagnostic center and database correspondingly.

Each category is assigned to an appender or the default root appender. The categories call the callback methods of the assigned appender. Appenders process the event data generated by the categories.

FileAppenderHelper 504

The FileAppenderHelper is a class, which is used to send the logs to the Rolling File Process.

DiagnosticAppenderHelper 506

The DiagnosticAppenderHelper is a class, which is used to send the logs to the Diagnostic center.

DataBaseAppenderHelper 508

The DataBaseAppenderHelper is a class, which is used to send the logs to the Database.

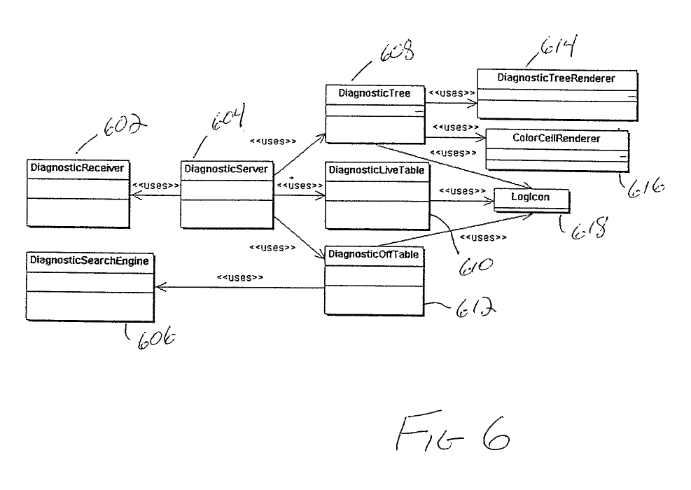

Package com.opuswave.ics.serviceEngine.icsLog.diagnosticsGUI (FIG. 6)

Classcom.opuswave.ics.serviceEngine.icsLog.diagnosticsGUI.ColorCellRenderer

Classcom.opuswave.ics.serviceEngine.icsLog.diagnosticsGUI.DiagnosticLiveTable

Classcom.opuswave.ics.serviceEngine.icsLog.diagnosticsGUI.DiagnosticOffTable

Classcom.opuswave.ics.serviceEngine.icsLog.diagnosticsGUI.DiagnosticReceiver

Classcom.opuswave.ics.serviceEngine.icsLog.diagnosticsGUI.DiagnosticSearchEngine

Class com.opuswave.ics.serviceEngine.icsLog.diagnosticsGUI.DiagnosticServer

Class com.opuswave.ics.serviceEngine.icsLog.diagnosticsGUI.DiagnosticTree

Class com.opuswave.ics.serviceEngine.icsLog.diagnosticsGUI.DiagnosticTreeRenderer

Class com.opuswave.ics.serviceEngine.icsLog.diagnosticsGUI.LogIcon

DiagnosticReceiver 602

This is a class, which is used to receive the logs from the ICSAppender and starts one child thread for getting all information from the received logging event object.

DiagnosticServer 604

This is a class, which acts as a controller to control the Diagnostic server. It controls the GUI and the receiver thread.

DiagnosticSearchEngine 606

This is a class, which is used to query the Rolling File Process for viewing the logs.

DiagnosticTree 608

This is a JTree class, which provides a nice graphical user interface for configuring the logging system.

DiagnosticLiveTable 610

This is a JPanel having a Live Table class, which provides a nice graphical user interface for viewing the logs.

DiagnosticOffTable 612

This is a JPanel having an Off Table class, which provides a nice graphical user interface for viewing the persisted logs.

DiagnosticTreeRenderer 614

This is a TreeRenderer class, which helps the tree nodes for different renderings.

ColorCellRenderer 616

This is a TableCellRenderer class, which helps the table cells for different renderings.

LogIcon 618

This is an Icon class, which helps in designing the different Icons.

Package com.opuswave.ics.serviceEngine.icsLog.helpers

Class com.opuswave.ics.serviceEngine.icsLog.helpers.CardAgent

CardAgent

This is a class, which acts like a process in every card and is used for updating the config file. The changed configuration content is received by diagnostic center which to be updated in every card.

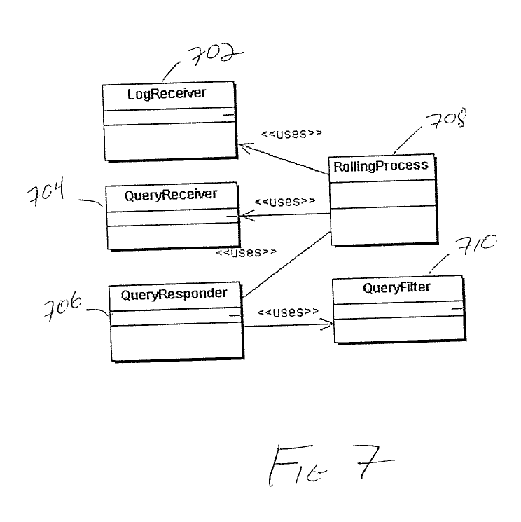

Package com.opuswave.ics.serviceEngine.icsLog.fileSystem (FIG. 7)

Class com.opuswave.ics.serviceEngine.icsLog.fileSystem.LogReceiver

Class com.opuswave.ics.serviceEngine.icsLog.fileSystem.QueryFilter

Class com.opuswave.ics.serviceEngine.icsLog.fileSystem.QueryReceiver

Class com.opuswave.ics.serviceEngine.icsLog.fileSystem.QueryResponder

Class com.opuswave.ics.serviceEngine.icsLog.fileSystem.RollingProcess

LogReceiver 702

This is a class, which is used to receive the logs from the ICSAppender.

QueryReceiver 704

This is a class, which is used to receive the queries from the Diagnostic center.

QueryResponder 706

This is a class, which is used to send the response of queries from the Diagnostic center.

RollingProcess 708

This is a class, which acts like a process and is used for maintaining the log file system. This acts like a controller to LogReceiver, QueryReceiver and QueryResponder.

QueryFilter 710

This is a class, which is used to filter the response of queries from the 10 Diagnostic center.

Topics

It will now be describe the role that “topics” play in the process of ICS logging and tracing. In a current embodiment, such logging and tracing system employs at least four topics:

Topic 1. Logging to diagnostic center

Topic 2. Updating the config file.

Topic 3. Logging to the Rolling File System.

Topic 4. Querying the Rolling File System.

Topic 1—Logging to Diagnostic Center

In the current embodiment of the present invention, one or more cards log onto one or more diagnostic centers via this topic. Regarding such logging, here are some of the attributes of this topic—logging onto a diagnostic center:

It is a synchronous communication.

It uses pub/sub style.

Any diagnostic center at the starting should subscribe to this topic.

You can run diagnostic center wherever you want with in the ICS network.

The DiagnosticAppeneder should publish the logs to this Topic only.

Topic 2—Updating the Config File

In the current embodiment, here are some of the attributes of this topic—updating the config file:

It is an asynchronous communication.

It uses the pub/sub style.

Any process in any card should subscribe to this Topic.

There are two Agents, Card Agent and Process Agent. Card Agent will be on each card and Process Agent will be on each Process.

Card Agent is having the responsibility to update the config file in that card.

Process Agent is having the responsibility to notify all the classes about the changed config file in that process.

Card Agent is separate process but Process Agent is with in each Process.

Diagnostic center from different cards publishes the config changes to this Topic.

Topic 3—Logging to the Rolling File System

In the current embodiment, here are some of the attributes of this topic—logging to the Rolling File System—where multiple cards can log onto rolling file systems via this topic:

It is an asynchronous communication.

It uses the pub/sub style.

Rolling File System at the starting should subscribe to this topic.

FileAppender publish all the logs from different processes and from different cards to this Topic.

Topic 4—Querying the Rolling File System

In the current embodiment, here are some of the attributes of this topic—querying the rolling file system—where multiple diagnostic centers at various cards may query a rolling file system:

It is a synchronous communication.

It uses the Point-to-Point style.

Rolling File System at the starting should subscribe to this queue.

Diagnostic center queries the Rolling File System for getting the data.

It will be appreciated that the recitation of these topics and their attributes pertain to the current embodiment of the present invention and that other topics and other attributes may apply within the spirit and scope of the present invention.

Diagnostic Center Use-Case Diagram

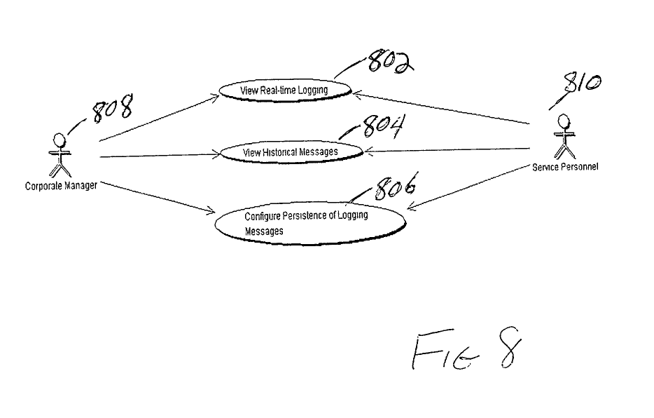

Having now given an internal view of the present invention, it will now be described the view presented to users of the present invention. FIG. 8 is a Use-Case diagram of the diagnostic center, as might be viewed by users of the system.

View Real-Time Logging Use Case (802):

In general, the user can view all of the messages being logged by all objects that have previously been set by the user to begin logging. The first time a user enters this view, there are no objects logging messages and, thus, no logging messages will be displayed. As the user starts selecting various objects to start logging messages, the logging messages will begin to scroll in the display.

The user can start viewing any messages being logged by an object by selecting the object and choosing a priority level. All messages being logged by that object at the selected priority level and below will be displayed. If a user wants to keep message from scrolling off the screen, the user could right-click on the message and choose a menu selection that keeps it in view.

The user can also choose to view all messages being logged according to a use-supplied string value. If the user has chosen several messages to keep in the view and wants to sort them, the user can select a column and choose to have the paused messages sorted in ascending or descending order. The user may also select to have a second column sorted in ascending or descending order. The speed that the messages scroll in the view can also be configured, but it will be from a different user interface than the one used for viewing.

In one embodiment of the present invention, the operator, using the Diagnostics center, can adjust the level of detail being reported by each network object/element connected to the diagnostics server. The diagnostics center client runs on each network element and listens for commands to be sent from the server. This allows the server to dynamically adjust the level (of detail) reported by the network element client. The main advantage of using this feature is to quickly narrow down a problem. For example, the operator can choose to turn the level way down or even off for network elements that are not the root cause of the problem and at the same time turn up the level of detail on elements that do seem to be the root cause.

Actors

Corporate Manager 808

Service Personnel 810

Basic Flow

| Actor | | System | |
|---|---|---|---|
| 1. | The user selects “Online”. | 2. | The system displays the |
| | | | “Online” section of the |
| | | | display. |
| | | 3. | If this is the first time |
| | | | the user selects “Online” |
| | | | since starting the |
| | | | Diagnostic Center, then |
| | | | the system has all log- |
| | | | ging turned off. |
| | | 4. | Else the system displays |
| | | | all logging messages the |
| | | | user has already con- |
| | | | figured to display. |
| 5. | For each logging object the user may | | |
| | choose to configure for online | | |
| | viewing: | | |

| | |
|---|---|
| a. | If the user does not want to see |
| | any logging messages, then the |
| | user right-clicks on the object |
| | and selects “Off”. |
| b. | Else if the user wants to see all |
| | exception priority level mes- |
| | sages, then the user right-clicks |
| | on the object and selects |
| | “Exception”. |
| c. | Else if the user wants to see all |
| | exception and Trace1 priority |
| | level messages, then the user |
| | right-clicks on the object and |
| | selects ”Trace1”. |
| d. | Else if the user wants to see all |
| | exception, Trace1, and Trace2 |
| | priority level messages, then the |
| | user right-clicks on the object |
| | and selects “Trace2”. |
| e. | Else if the use wants to see all |
| | exception, Trace1, Trace2, and |
| | Trace3 priority level messages, |
| | then the user right-clicks on the |
| | object and selects “Trace3”. |
| f. | Else if the user wants to see all |
| | exception, Trace1, Trace2, |
| | Trace3, and Trace4 priority level |
| | messages, then the user right- |
| | clicks on the object and selects |
| | “Trace4”. |

| | | | |
|---|---|---|---|
| 6. | The user selects “Configure”. | 7. | The system displays |
| | | | logging messages for all |
| | | | objects according to their |
| | | | priority level settings. |
| 8. | For each message that the user wants | | |
| | to keep in the message view: | | |

| | | | |
|---|---|---|---|
| a. | The user right-clicks on the | b. | The system will |
| | logging message and selects | | keep the selected |
| | “Keep in Display”. | | message in the mes- |
| | | | sage view while all |
| | | | other messages, not |
| | | | so chosen, will con- |
| | | | tinue to scroll. |

Supplementary Specifications

1. The configuration settings made by a particular user are specific to that user's view. In other words, two or more users performing this use case at the same time will operate independently of each other's settings.

View Historical Messages Use Case (804):

The user can view historical messages, messages that have been persisted previously. The user can set certain criteria to filter messages. Filter criteria include: message severity level, date of message, or the object that logged the message.

Actors

Corporate Manager 808

Service Personnel 810

Preconditions

1. User has successfully completed the login use case.

Basic Flow

| Actor | | System | |
|---|---|---|---|
| 1. | The user selects “offline”. (Or, the | 2. | The system displays the |
| | user selects “View Log History”.) | | “Offline” section of the |
| 3. | If the user wants to see all exception | | screen. |
| | priority level logging information, | | |
| | then the user selects “Exception | | |
| | Messages”. | | |
| 4. | If the user wants to see all Trace1 | | |
| | priority level logging information, | | |
| | then the user selects “Trace1 | | |
| | Messages”. | | |
| 5. | If the user wants to see all Trace2 | | |
| | priority level logging information, | | |
| | then the user selects “Trace2 | | |
| | Messages”. | | |
| 6. | If the user wants to see all Trace3 | | |
| | priority level logging information, | | |
| | then the user selects “Trace3 | | |
| | Messages”. | | |
| 7. | If the user wants to see all Trace4 | | |
| | priority level logging information, | | |
| | then the user selects “Trace4 | | |
| | Messages”. | | |
| 8. | If the user wants to see only | | |
| | messages during a particular time | | |
| | period, then the user selects a start | | |
| | date, or a start date and end date, or | | |
| | an end date. | | |
| 9. | If the user wants to see only | | |
| | messages from a particular diagnostic | | |
| | source: | | |

| | a. | The user selects a particular | b. | The system popu- |
|---|---|---|---|---|
| | | diagnostic source from the | | lates the “Objects” |
| | | “Diagnostic Sources” list. (A | | list with all of the |
| | | “Diagnostic Source” translates | | objects associated |
| | | to a package in Java, a name- | | with the selected |
| | | space in C++, etc.) | | Diagnostic Source. |
| | | | | (An “Object” is a |
| | | | | class.) |
| | c. | The user selects a particular Ob- | | |
| | | ject or all objects from the “Ob- | | |
| | | jects” list. | | |
| 10. | Else if the user wants to see all log- | | | |
| | ging messages from all Diagnostic | | | |
| | Sources: | | | |
| | a. | the use selects “All” from the | b. | The system pop- |
| | | “Diagnostic Sources” list. | | ulates the “Objects” |
| | | | | list with the entry |
| | | | | “All”. |

| | | | |
|---|---|---|---|
| 11. | The user selects “Show Messages”. | 12. | The system retrieves the |
| | | | historical messages |
| | | | according to intersection |
| | | | of the choices made in |
| | | | steps 3-10 and the set |
| | | | of logging messages per- |
| | | | sisted according to the |
| | | | Configure Persistence of |
| | | | Logging Messages Use |
| | | | Case. |
| | | 13. | The system displays the |
| | | | historical messages in the |
| | | | “Messages” list. |
| | | 14. | The first historical mes- |
| | | | sage in the “Messages” |
| | | | list is highlighted and |
| | | | shown in full in the |
| | | | “Message Details” sec- |
| | | | tion of the screen. |
| 15. | If the user wants to see the whole | 16. | The system displays the |
| | historical message, then the user | | historical message in full |
| | selects an historical message in the | | in the “Message Details” |
| | “Messages” list. | | section of the screen. |
| 17. | If the user wants to clear all messages | 18. | The system removes all |
| | from the “Messages” list, then the | | historical messages from |
| | user selects “Clear All Messages”. | | the “Messages” list and |
| | | | removes the historical |
| | | | message from the “Mes- |
| | | | sage Details” section |
| | | | of the screen. |

Related Use Cases

1. Configure Persistence of Logging Messages Use Case

Configure Persistence of Logging Messages Use Case (806):

The user configures the parameters that determine which logging messages are persisted. The system always persists messages of priority level “exception”. The user can choose to have the system persist higher level logging messages.

Actors

Corporate Manager 808

Service Personnel 810

Basic Flow

| Actor | | System | |
|---|---|---|---|
| 1. | The user selects “Configure Log | 2. | The system displays the |
| | Persistence”. | | “Configure Log Persis- |
| 3. | For each logging object the user may | | tence” section of the |
| | choose to configure for persistent | | screen. |
| | logging: | | |

| | |
|---|---|
| a. | If the user wants to have only |
| | exception priority level mes- |
| | sages persisted, then the user |
| | right-clicks on the object and |
| | selects “Exception”. |
| b. | Else if the user wants to have |
| | only exception and Trace1 pri- |
| | ority level messages persisted, |
| | then the user right-clicks on the |
| | object selects “Trace1”. |
| c. | Else if the user wants to have |
| | only exception, Trace1, and |
| | Trace2 priority level messages |
| | persisted, then the user right- |
| | clicks on the object and selects |
| | “Trace3”. |
| d. | Else if the user wants to have |
| | only exception, Trace1, Trace2, |
| | and Trace3 priority level mes- |
| | sages persisted, then the user |
| | right clicks on the object and |
| | selects “Trace3”. |
| e. | Else if the user wants to have |
| | exception, Trace1, Trace2, |
| | Trace3, and Trace4, logged, then |
| | the user right-clicks on the ob- |
| | ject and selects “Trace4”. |

| | | | |
|---|---|---|---|
| 4. | The user presses “Configure”. | 5. | The system persistently |
| | | | stores the messages from |
| | | | logging objects according |
| | | | to their message severity |
| | | | configuration. |

Supplementary Specifications

1. The settings made in this use case are system wide-the settings affect how the system as a whole persists logging information.

It has now been disclosed a novel method and system for a logging program trace data in a distributed network. It will be appreciated that the scope of the present invention should not be limited by the recitation of embodiments disclosed herein. Moreover, the scope of the present invention contemplates all obvious variations and enhancements to the embodiments disclosed.

1. In a network, said network comprising multiple components coupled in a distributed manner wherein distributed programs execute across said multiple components and data associated with the execution of said distributed programs is generated by said multiple components:
a method for logging distributed program trace data, the steps of said method comprising:
generating data associated with the execution of said distributed programs from each said multiple components;
processing said data associated with the execution of said distributed programs from each said multiple components; and
displaying said processed data to a user, said data associated with the execution of said distributed programs generated by said multiple components for a user of said network.

2. The method as recited in claim 1 further comprising:
communicating said processed data to one of a group, said group comprising data services, rolling file systems, and a diagnostic center.

3. The method as recited in claim 1 further comprising:
communicating said processed data to a diagnostic center, said diagnostic center controlling all logging data across the entire network.

4. The method as recited in claim 1 wherein said method further comprises:
dynamically configuring said network to selectively provide logging data from a subset of said multiple components.

5. The method as recited in claim 1 wherein said method further comprises:
configuring said network to selectively set options for persistently storing a subset of said logging data.

6. The method as recited in claim 1 wherein said method further comprises:
dynamically configuring said network to selectively provide logging data from a subset of said multiple components; and
configuring said network to selectively set options for persistently storing a subset of said logging data.

7. The method as recited in claim 1 wherein said method further comprises:
displaying said processed data on a graphical user interface for one or more users of said network.

8. The method as recited in claim 1 wherein said method further comprises:
configuring said network to selectively provide logging data via a graphical user interface, said user interface enabled to receive user commands for configuring said network.

9. In a distributed network, said network comprising multiple components and wherein distributed programs execute across said multiple components:
a system for logging a trace of said distributed programs, said system comprising:
a means for generating data associated with the execution of said distributed programs from each said multiple components;
a means for processing said data associated with the execution of said distributed programs from each said multiple components; and
a means for displaying said processed data to a user, said data associated with the execution of said distributed programs generated by said multiple components for a user of said network.

10. The system as recited in claim 9 further comprising:
a means for communicating said processed data to one of a group, said group comprising data services, rolling file systems, and a diagnostic center.

11. The system as recited in claim 9 further comprising:
a means for communicating said processed data to a diagnostic center, said diagnostic center controlling all logging data across the entire network.

12. The system as recited in claim 9 further comprising:
a means for dynamically configuring said network to selectively provide logging data from a subset of said multiple components.

13. The system as recited in claim 9 further comprising:
a means for configuring said network to selectively set options for persistently storing a subset of said logging data.

14. The system as recited in claim 9 further comprising:
a means for dynamically configuring said network to selectively provide logging data from a subset of said multiple components; and
a means for configuring said network to selectively set options for persistently storing a subset of said logging data.

15. The system as recited in claim 9 further comprising:
a means for displaying said processed data on a graphical user interface for one or more users of said network.

16. The system as recited in claim 9 further comprising:
a means for configuring said network to selectively provide logging data via a graphical user interface, said user interface enabled to receive user commands for configuring said network.

17. In a distributed network, said network comprising multiple components and wherein distributed programs execute across said multiple components:
a system for logging a trace of said distributed programs, said system comprising:
one or more categories, said categories generating data associated with the execution of said distributed programs;
one or more appenders, said appenders processing said data generated by said one or more categories; and
a means for displaying said data processed by said appenders, said data associated with the execution of said distributed programs generated by said multiple components for a user of said network.

18. A method for dynamically adjusting the level of diagnostics data, the steps of said method comprising:
connecting a plurality of network elements to a diagnostic center; and
dynamically adjusting the level of detail of diagnostic data sent from each said plurality of network elements to an operator in accordance with commands sent by said operator.

19. The method as recited in claim 18 wherein said step of dyamically adjusting the level of detail of diagnostic data further comprises decreasing the amount of diagnostic data from a selected set of network elements.

20. The method as recited in claim 18 wherein said step of dyamically adjusting the level of detail of diagnostic data further comprises turning off the flow of diagnostic data from a selected set of network elements.

21. The method as recited in claim 18 wherein said step of dyamically adjusting the level of detail of diagnostic data further comprises increasing the amount of diagnostic data.
